(19) United States
(12) Patent Application Publication
(10) Pub. No.: US 2014/0218617 A1
(43) Pub. Date: Aug. 7, 2014

(54) Display Device

(71) Applicant: Funai Electric Co., Ltd., Osaka (JP)

(72) Inventor: Naoki HONGO, Daito-shi (JP)

(73) Assignee: Funai Electric Co., Ltd., Osaka (JP)

(21) Appl. No.: 14/165,884

(22) Filed: Jan. 28, 2014

(30) Foreign Application Priority Data
Feb. 5, 2013 (JP) 2013-020896

(51) Int. Cl. F21V 29/00; H04N 5/64; F21V 8/00

(52) U.S. Cl. CPC F21V 29/2293; G02B 6/0031; H04N 5/64
USPC 348/725; 362/609

(57) ABSTRACT

A display device includes a display portion displaying an image on the front side, a light guide plate arranged on the rear side of the display portion, a heat radiation member arranged on the rear side of the light guide plate, radiating the heat of the light source, and a reflective sheet arranged between the light guide plate and the heat radiation member, including a heat reflecting portion capable of reflecting the heat radiated from the heat radiation member to the heat radiation member on the rear side, while the heat radiation member includes a heat releasing portion configured to release the heat reflected by the heat reflecting portion to the rear side of the heat radiation member.

### BACKGROUND OF THE INVENTION

1. Field of the Invention

The present invention relates to a display device, and more particularly, it relates to a display device including a heat radiation member.

2. Description of the Background Art

A display device including a heat radiation member is known in general, as disclosed in Japanese Patent Laying-Open No. 2006-235093, for example.

The aforementioned Japanese Patent Laying-Open No. 2006-235093 discloses a display device including a liquid crystal panel (display portion) displaying an image on the front side and a light guide plate arranged on the rear side of the liquid crystal panel, guiding backlight emitted from a light-emitting diode (light source) to the liquid crystal panel. This display device further includes a heat radiation member arranged on the rear side of the light guide plate, radiating the heat of the light-emitting diode and a reflective sheet arranged between the light guide plate and the heat radiation member.

In the display device according to the aforementioned Japanese Patent Laying-Open No. 2006-235093, however, the heat radiated from the heat radiation member is transferred to the light guide plate through the reflective sheet, whereby the shape of the heat radiation member may be reflected in a display surface of the liquid crystal panel, and hence a user may visually recognize the shape of the heat radiation member. Therefore, the display quality of the display device is disadvantageously reduced by the heat radiated from the heat radiation member.

### SUMMARY OF THE INVENTION

The present invention has been proposed in order to solve the aforementioned problem, and an object of the present invention is to provide a display device capable of suppressing a reduction in the display quality thereof resulting from heat radiated from the heat radiation member.

A display device according to an aspect of the present invention includes a display portion displaying an image on the front side, a light guide plate arranged on the rear side of the display portion, guiding backlight emitted from a light source to the display portion, a heat radiation member arranged on the rear side of the light guide plate, radiating the heat of the light source, and a reflective sheet arranged between the light guide plate and the heat radiation member, including a heat reflecting portion capable of reflecting the heat radiated from the heat radiation member to the heat radiation member on the rear side, while the heat radiation member includes a heat releasing portion configured to release the heat reflected by the heat reflecting portion to the rear side of the heat radiation member.

In the display device according to the aspect of the present invention, as hereinabove described, the reflective sheet arranged between the light guide plate and the heat radiation member, including the heat reflecting portion capable of reflecting the heat radiated from the heat radiation member to the heat radiation member on the rear side is provided, and the heat radiation member includes the heat releasing portion configured to release the heat reflected by the heat reflecting portion to the rear side of the heat radiation member, whereby accumulation of the heat reflected by the heat reflecting portion between the heat reflecting portion (reflective sheet) and the heat radiation member can be suppressed by releasing the heat reflected by the heat reflecting portion to the rear side of the heat radiation member while the heat reflecting portion suppresses transfer of the heat radiated from the heat radiation member to the light guide plate on the front side through the reflective sheet. Thus, a user can be suppressed from visually recognizing the shape of the heat radiation member due to the heat radiated from the heat radiation member. Consequently, a reduction in the display quality of the display device resulting from the heat radiated from the heat radiation member can be suppressed.

In the aforementioned display device according to the aspect, the heat releasing portion preferably includes a heat releasing hole that is a through-hole. According to this structure, the heat releasing hole serving as the heat releasing portion can be easily provided.

In this case, the heat releasing portion of the heat radiation member preferably includes a plurality of heat releasing holes, the plurality of heat releasing holes are preferably formed at positions of the reflective sheet opposed to the heat reflecting portion, and the heat reflected to the heat radiation member by the heat reflecting portion is preferably released to the rear side of the heat radiation member through the plurality of heat releasing holes. According to this structure, the heat reflected to the heat radiation member by the heat reflecting portion can be easily released to the rear side of the heat radiation member through the plurality of heat releasing holes, and hence the accumulation of the heat reflected by the heat reflecting portion between the heat reflecting portion (reflective sheet) and the heat radiation member can be easily suppressed.

In the aforementioned structure including the plurality of heat releasing holes, the plurality of heat releasing holes are preferably arranged such that the centers thereof are spaced from each other at a substantially equal distance. According to this structure, the plurality of heat releasing holes are arranged in a balanced manner, and the heat reflected by the heat reflecting portion is released to the rear side of the heat radiation member, whereby the accumulation of the heat reflected by the heat reflecting portion between the heat reflecting portion and the heat radiation member can be effectively suppressed.

In the aforementioned structure including the plurality of heat releasing holes, the heat releasing holes of the heat radiation member are preferably formed such that the opening density of the heat releasing holes is increased as the distance of the heat releasing holes from the light source is increased. According to this structure, the heat of the light source can be efficiently absorbed by the heat radiation member in a region where the distance of the heat releasing holes from the light source is relatively small, and the heat reflected to the heat radiation member by the heat reflecting portion can be efficiently released to the rear side of the heat radiation member through the heat releasing holes in a region where the distance of the heat releasing holes from the light source is relatively large. Thus, the reduction in the display quality of the display device resulting from the heat radiated from the heat radiation member can be suppressed while the light source is efficiently cooled.

In the aforementioned structure in which the heat releasing holes are formed such that the opening density of the heat releasing holes is increased as the distance of the heat releasing holes from the light source is increased, the heat releasing holes of the heat radiation member are preferably formed such that the total opening area of the heat releasing holes is increased as the distance of the heat releasing holes from the light source is increased. According to this structure, the opening density can be easily increased as the distance of the heat releasing holes from the light source is increased, and hence the heat of the light source can be easily, efficiently absorbed by the heat radiation member in the region where the distance of the heat releasing holes from the light source is relatively small, and the heat reflected to the heat radiation member by the heat reflecting portion can be easily, efficiently released to the rear side of the heat radiation member through the heat releasing holes in the region where the distance of the heat releasing holes from the light source is relatively large.

In the aforementioned structure in which the heat releasing holes are formed such that the opening density of the heat releasing holes is increased as the distance of the heat releasing holes from the light source is increased, the inner diameter of the plurality of heat releasing holes is preferably increased as the distance of the heat releasing holes from the light source is increased. According to this structure, the inner diameter of the heat releasing holes is increased, whereby the opening density can be easily increased.

In the aforementioned structure in which the heat releasing portion includes the heat releasing hole that is a through-hole, the heat radiation member is preferably formed of a plate-like metal member, and the heat releasing hole is preferably formed in the heat radiation member that is plate-like. According to this structure, the heat of the light source can be efficiently radiated by the heat radiation member formed of the plate-like metal member, and the heat releasing hole can be easily formed in the heat radiation member that is plate-like.

In the aforementioned structure including the plurality of heat releasing holes, the heat radiation member and the heat reflecting portion of the reflective sheet are preferably arranged in a state where the heat radiation member and the heat reflecting portion of the reflective sheet are separated from each other at a prescribed interval in an anteroposterior direction, and the heat radiation member is preferably configured to release the heat reflected by the heat reflecting portion to the rear side through the heat releasing holes. According to this structure, unlike the case where the heat radiation member and the heat reflecting portion are in direct contact with each other, heat is radiated from the heat radiation member to the heat reflecting portion through air between the heat radiation member and the heat reflecting portion, and hence the heat of the heat radiation member is hardly directly transferred to the heat reflecting portion.

In the aforementioned structure in which the heat radiation member and the heat reflecting portion are arranged in the state where the heat radiation member and the heat reflecting portion are separated from each other at the prescribed interval in the anteroposterior direction, the display device preferably further includes a rear frame arranged on the rear side of the heat radiation member, and the heat released to the rear side through the heat releasing holes is preferably radiated through the rear frame. According to this structure, the heat released to the rear side through the heat releasing holes can be easily radiated through the rear frame.

The aforementioned display device according to the aspect preferably further includes a rear frame made of resin, arranged on the rear side of the heat radiation member, and the rear frame is preferably configured such that the inner surface thereof is blackish colored. According to this structure, unlike the case where the inner surface of the rear frame is white, the heat released to the rear side of the heat radiation member can be efficiently absorbed by the blackish colored rear frame. Thus, the accumulation of the heat reflected by the heat reflecting portion between the heat reflecting portion (reflective sheet) and the heat radiation member can be effectively suppressed.

In the aforementioned display device according to the aspect, the reflective sheet is preferably made of resin, and a heat reflecting layer made of metal, capable of reflecting the heat radiated from the heat radiation member to the heat radiation member is preferably formed on the rear side of the reflective sheet. According to this structure, transfer of the heat radiated from the heat radiation member to the display portion can be easily suppressed by the heat reflecting layer made of metal even in the case where the reflective sheet is made of resin. Furthermore, the reflective sheet formed with the heat reflecting layer on the rear side is provided, whereby the number of components can be reduced, unlike the case where a dedicated heat reflecting portion is separately provided.

In this case, the heat reflecting layer is preferably formed of a tape member made of metal or formed by depositing metal on the reflective sheet. According to this structure, the heat reflecting layer can be thinned, and hence an increase in the thickness of the display device in the anteroposterior direction can be suppressed.

In the aforementioned display device according to the aspect, a plurality of light sources are preferably arranged to be opposed to a side surface of the light guide plate serving as a light incident surface, and the heat reflecting portion is preferably formed from a region corresponding to an end of a first side along the light incident surface in a direction in which the light source is arranged to a region corresponding to an end of the second side along the light incident surface in the reflective sheet. According to this structure, the heat reflecting portion can be provided in a region in the vicinity of the light sources where the temperature of the heat radiation member is easily increased, and hence the transfer of the heat radiated from the heat radiation member to the display portion can be effectively suppressed by the heat reflecting portion.

In the aforementioned structure including the plurality of heat releasing holes, the heat releasing holes of the heat radiation member are preferably formed such that the total opening area of the heat releasing holes is reduced as the distance of the heat releasing holes from the light source is increased. According to this structure, the heat reflected to the heat radiation member by the heat reflecting portion can be promptly released to the rear side of the heat radiation member through the heat releasing holes in the vicinity of the light source, and hence the amount of heat diffusing to a region of the heat radiation member corresponding to the central side of the display portion is reduced, so that accumulation of heat in the region of the heat radiation member corresponding to the central side of the display portion can be suppressed. Consequently, a reduction in the display quality of a central region of the display device can be further suppressed.

In the aforementioned display device according to the aspect, the heat radiation member is preferably arranged to overlap with the heat reflecting portion of the reflective sheet. According to this structure, the heat reflected by the heat reflecting portion can be efficiently radiated from the heat radiation member.

In the aforementioned structure in which the heat radiation member is arranged to overlap with the heat reflecting portion of the reflective sheet, at least the heat releasing portion of the heat radiation member is preferably formed in the heat radiation member to overlap with the heat reflecting portion of the reflective sheet. According to this structure, the heat reflected by the heat reflecting portion can be efficiently released to the rear side of the heat radiation member.

In the aforementioned structure including the rear frame, an interval between the heat radiation member and a flat portion of the rear frame is preferably larger than an interval between the heat radiation member and the reflective sheet. According to this structure, the heat reflected by the heat reflecting portion can be suppressed from staying between the heat radiation member and the rear frame.

The aforementioned display device according to the aspect is preferably a television set including a receiver receiving television broadcasting. The present invention is also applicable to the television set.

According to the present invention, as hereinabove described, the reduction in the display quality of the display device resulting from the heat radiated from the heat radiation member can be suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall structure of a TV according to an embodiment of the present invention;

FIG. 2 is a diagram showing a heat sink fixed to a rear frame of the TV according to the embodiment of the present invention;

FIG. 3 is a diagram showing the heat sink of the TV according to the embodiment of the present invention;

FIG. 4 is a diagram showing a heat reflecting portion of the TV according to the embodiment of the present invention;

FIG. 5 is a sectional view taken along the line 500-500 in FIG. 1;

FIG. 6 is a diagram showing the heat sink and the heat reflecting portion of the TV according to the embodiment of the present invention;

FIG. 7 is a diagram showing a heat sink of a TV according to a first modification of the embodiment of the present invention;

FIG. 8 is a diagram showing a heat sink of a TV according to a second modification of the embodiment of the present invention;

FIG. 9 is a diagram showing a heat sink of a TV according to a third modification of the embodiment of the present invention; and

FIG. 10 is a diagram showing a heat reflecting portion of a TV according to a fourth modification of the embodiment of the present invention.

### DESCRIPTION OF THE PREFERRED EMBODIMENTS

An embodiment of the present invention is hereinafter described with reference to the drawings.

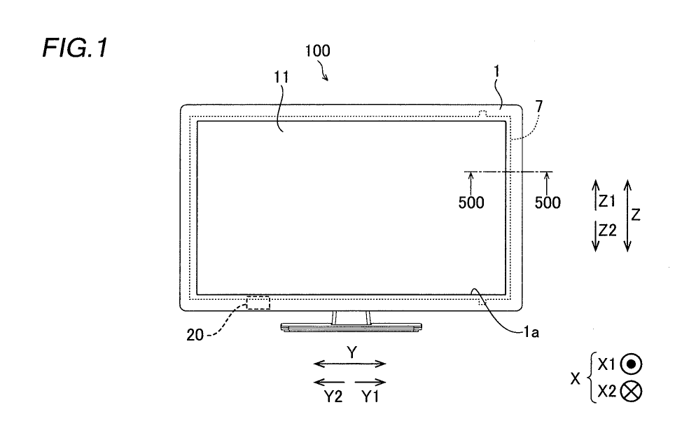

The structure of a TV (television set) 100 according to the embodiment of the present invention is now described with reference to FIGS. 1 to 6. The TV 100 is an example of the “display device” in the present invention.

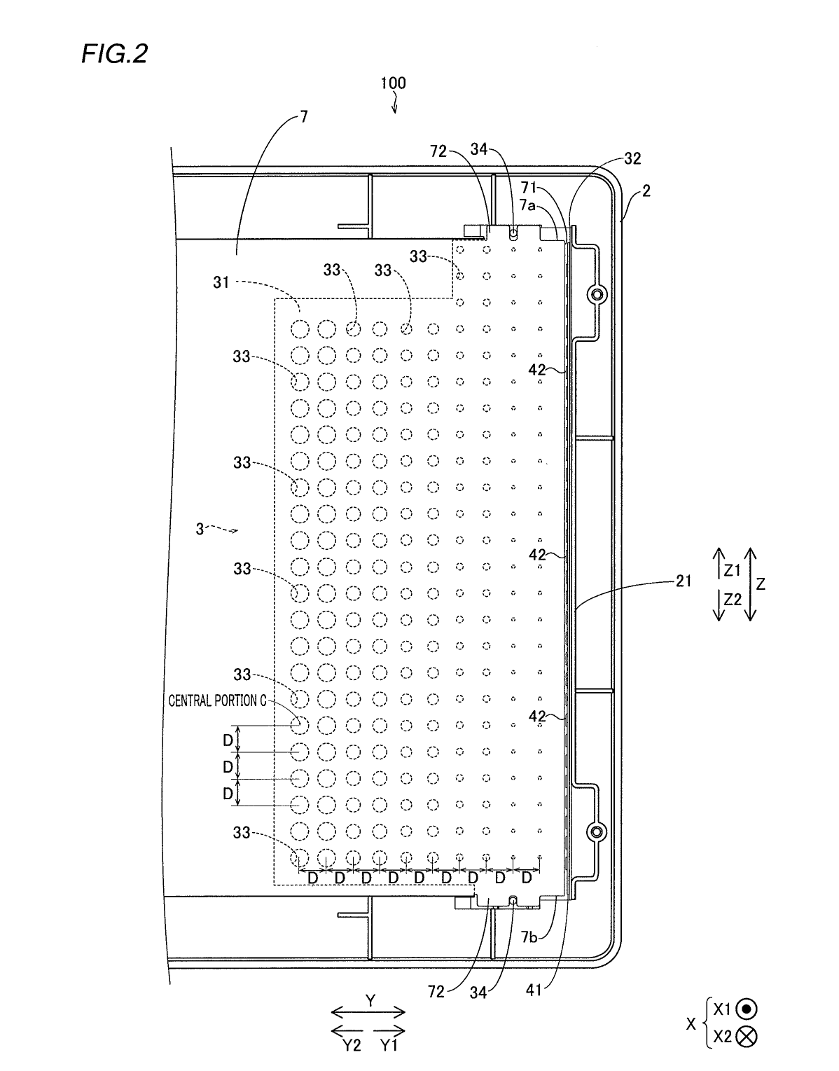

The TV 100 according to the embodiment of the present invention includes a front frame 1 having an opening 1a and a rear frame 2 (see FIG. 2), as shown in FIG. 1. An antireflection sheet 11 (display portion 10) is exposed from the opening 1a of the front frame 1. The TV 100 is configured to be capable of receiving a broadcast signal through a receiving portion 20.

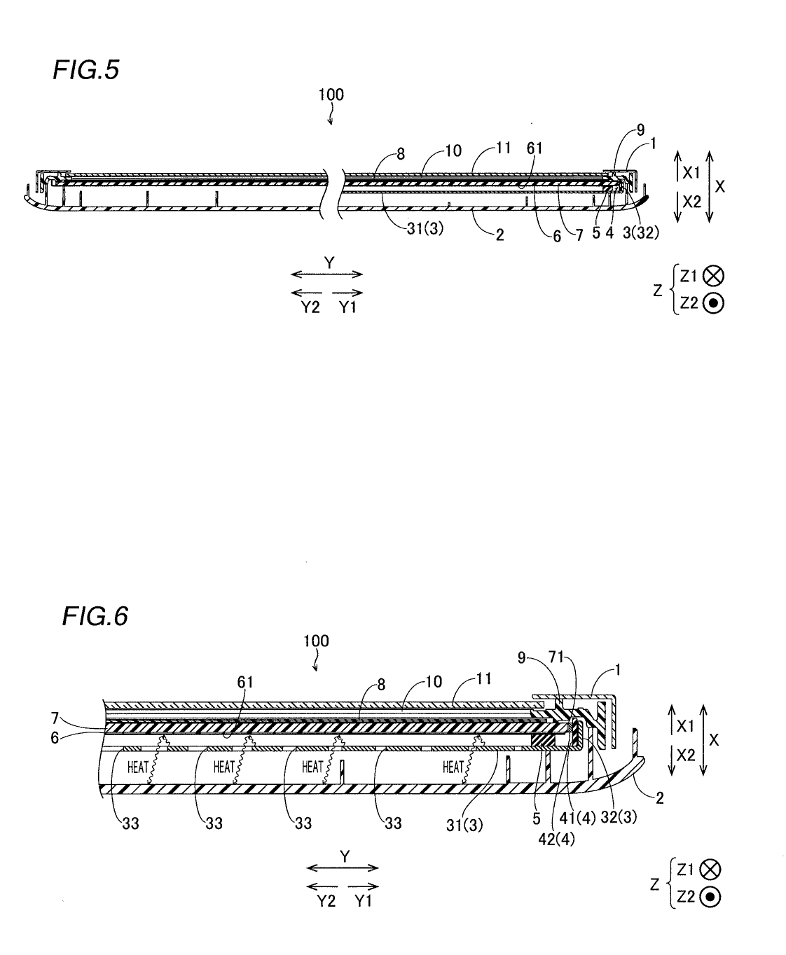

Inside the TV 100, a heat sink 3 and an LED module 4 including a plurality of LEDs 42 (see FIG. 6) are provided, as shown in FIGS. 5 and 6. On the front side (X1 side) of the heat sink 3, a cushion 5, a reflective sheet 6, a light guide plate 7, and an optical sheet 8 are stacked sequentially from the rear side (X2 side). On the front side of an LED substrate 41, a resin frame 9 is arranged. On the front side of the resin frame 9, the display portion 10 and the antireflection sheet 11 are arranged in this order. The LEDs 42 are examples of the “light source” in the present invention.

According to this embodiment, the rear frame 2 is arranged on the rear side (X2 side) of the heat sink 3, as shown in FIGS. 2, 5, and 6. On the Y1 side of the rear frame 2, a rib-like restriction portion 21 (see FIG. 2) restricting movement of the heat sink 3 along arrow Y1 is formed. The rear frame 2 is made of black resin such that the inner surface thereof on the X1 side is black. This black resin can efficiently absorb heat transferred as an infrared ray (electromagnetic wave). The heat sink 3 is an example of the “heat radiation member” in the present invention.

According to this embodiment, the heat sink 3 is arranged on the rear side (X2 side) of the light guide plate 7, as shown in FIGS. 2, 5, and 6. The rear frame 2 is arranged on the rear side of the heat sink 3. The heat sink 3 has a function of radiating the heat of the LEDs 42. The heat sink 3 is made of a plate-like metal material of aluminum or the like, for example. The heat sink 3 includes a heat sink body portion 31 and an LED substrate fixing portion 32, as shown in FIGS. 2, 3, 5, and 6. The heat sink body portion 31 is flattened to extend in a Y-Z direction. The LED substrate fixing portion 32 is formed by substantially vertically bending a part of the heat sink 3 on the Y1 side to the front side (X1 side).

The heat sink 3 is formed in a shape corresponding to a partial region of the light guide plate 7 on the Y1 side, as shown in FIG. 2. Specifically, the heat sink 3 is formed from a region in the vicinity of an end 7a of the light guide plate 7 on a first side (Z1 side) along a light incident surface 71 to a region in the vicinity of an end 7b of the light guide plate 7 on a second side (Z2 side) along the light incident surface 71. The heat sink 3 has a schematically rectangular shape in a plan view, as viewed in a direction X.

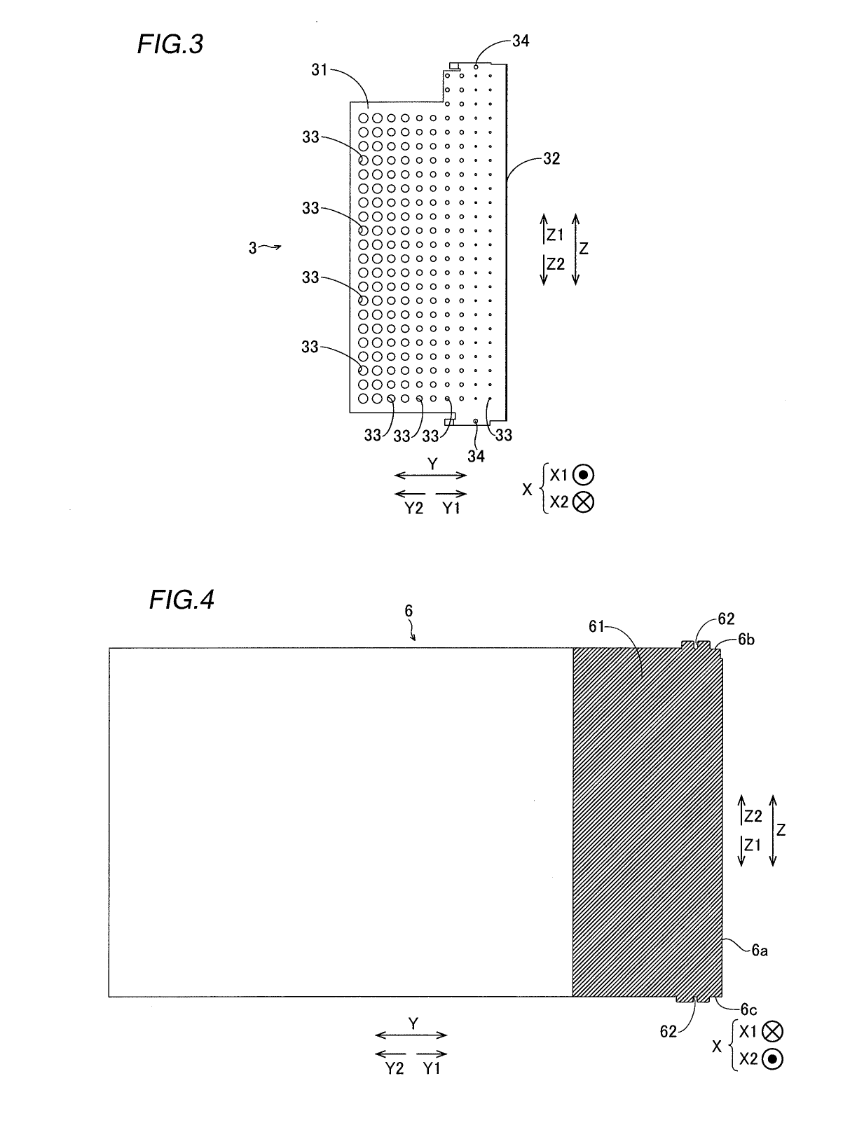

The heat sink 3 includes a plurality of heat releasing holes 33 configured to release heat reflected by a heat reflecting portion 61 described later to the rear side (X2 side) of the heat sink 3, as shown in FIGS. 2 and 3. The heat released to the rear side through the heat releasing holes 33 is radiated in the air through the rear frame 2. The heat releasing holes 33 are through-holes formed in the heat sink 3. The heat releasing holes 33 are formed in the heat sink 3 to overlap with the reflective sheet 6 (heat reflecting portion 61). The opening density (the rate of the opening area of the heat releasing holes 33 per unit area) of the heat releasing holes 33 is increased as the distance of the heat releasing holes 33 from the LEDs 42 is increased. Specifically, of the plurality of heat releasing holes 33, the inner diameter of heat releasing holes 33 closer to the Y1 side is relatively small, and the inner diameter of heat releasing holes 33 closer to the Y2 side is relatively large. In other words, the inner diameter of the heat releasing holes 33 is increased as the distance of the heat releasing holes 33 from the LEDs 42 is increased. As the distance (in a direction Y) of the heat releasing holes 33 from the LEDs 42 is increased, the total opening area of the heat releasing holes 33 arranged along a direction Z at each position (in the direction Y) is increased. As the heat releasing holes 33 are from the Y1 side toward the Y2 side, the opening area (inner diameter) of the heat releasing holes 33 is gradually increased. Furthermore, the heat releasing holes 33 each are formed in a substantially circular shape. The plurality of heat releasing holes 33 are arranged substantially linearly along the direction Z. In addition, the plurality of heat releasing holes 33 are arranged substantially linearly along the direction Y. The plurality of heat releasing holes 33 are arranged at prescribed distances D. Specifically, the plurality of heat releasing holes 33 are arranged such that central portions C of the heat releasing holes 33 are spaced from each other at the equal distances D, as shown in FIG. 2. The heat releasing holes 33 are examples of the “heat releasing portion” in the present invention.

The heat sink 3 is provided with a pair of protrusion portions 34 configured to position the reflective sheet 6 and the light guide plate 7, as shown in FIG. 2. The protrusion portions 34 are provided on the Z1 side and the Z2 side of the heat sink 3, respectively. The protrusion portions 34 are formed to protrude to the X1 side.

An interval between the heat sink 3 and a flat portion (a portion substantially parallel to the reflective sheet 6) of the rear frame 2 is larger than an interval between the heat sink 3 and the reflective sheet 6.

The LED module 4 includes the LED substrate 41 and the plurality of LEDs 42 mounted on the LED substrate 41, as shown in FIG. 2. The plurality of LEDs 42 are arranged to be opposed to the light incident surface 71 of the light guide plate 7. The LEDs 42 are configured to supply light to the display portion 10 through the light guide plate 7. The LED module 4 is arranged on the right side (Y1 side) when the TV 100 (see FIG. 1) is viewed from the front side, as shown in FIGS. 2, 5, and 6. The LED module 4 is configured such that the LED substrate 41 is fixed to a surface on the Y2 side of the LED substrate fixing portion 32 of the heat sink 3 by a double-faced adhesive tape (not shown).

The cushion 5 is arranged on the front side (X1 side) of the heat sink 3, as shown in FIGS. 5 and 6. The cushion 5 is configured such that the section thereof in the direction Z has a substantially rectangular shape. The cushion 5 is configured to support the light guide plate 7 facing the front side (X1 side). Furthermore, the cushion 5 is arranged at a prescribed interval from the LED substrate fixing portion 32 of the heat sink 3, as shown in FIGS. 5 and 6. The cushion 5 is made of a material (urethane foam or the like, for example) absorbing a shock.

According to this embodiment, the reflective sheet 6 is arranged on the X2 side of the light guide plate 7, as shown in FIGS. 4 to 6. The reflective sheet 6 has a function of suppressing light leakage to the rear side (X2 side) of the light guide plate 7. Furthermore, the reflective sheet 6 is formed in a shape corresponding to that of the light guide plate 7. The reflective sheet 6 is made of resin. The reflective sheet 6 is arranged between the light guide plate 7 and the heat sink 3 and includes the heat reflecting portion (stratified heat reflecting layer) 61 capable of reflecting heat radiated from the heat sink 3 to the heat sink 3 on the rear side (X2 side), as shown in FIGS. 5 and 6. The heat reflecting portion 61 and the heat sink 3 are arranged in a state where the same are separated from each other at a prescribed interval in an anteroposterior direction (direction X). The reflective sheet 6 has a pair of positioning portions 62 in a vertical direction (direction Z), as shown in FIG. 4. The positioning portions 62 are formed at positions corresponding to the protrusion portions (see FIG. 2) of the heat sink 3. The positioning portions 62 engage with the protrusion portions 34 of the heat sink 3, whereby the reflective sheet 6 is arranged at a prescribed position.

The heat reflecting portion 61 roughly has a substantially rectangular shape in a plan view, as shown in FIG. 4. The heat reflecting portion 61 is formed from a region corresponding to an end 6b of a first side (Z2 side) along a side surface 6a in a direction (direction Z) in which the LEDs 42 are arranged to a region corresponding to an end 6c of a second side (Z1 side) along the side surface 6a in the reflective sheet 6. The heat reflecting portion 61 is arranged in the vicinity of the light incident surface 71 (see FIG. 6), as shown in FIGS. 2 and 6. Furthermore, the heat reflecting portion 61 is formed in a shape corresponding to that of the heat sink 3, as shown in FIGS. 3 and 4. The heat sink 3 is arranged to overlap with the heat reflecting portion 61 of the reflective sheet 6.

As shown in FIGS. 2, 5, and 6, the plurality of heat releasing holes 33 are formed at positions of the heat sink 3 opposed to the heat reflecting portion 61. As shown in FIG. 6, the heat reflected to the heat sink 3 by the heat reflecting portion 61 is released from the plurality of heat releasing holes 33 to the rear side (X2 side) of the heat sink 3. The heat reflecting portion 61 is provided by applying a tape made of metal (aluminum, for example) to the rear side of the reflective sheet 6, as shown in FIGS. 4 to 6. The heat reflecting portion 61 may be formed of a heat reflecting layer of metal formed by depositing metal on the rear side of the reflective sheet 6.

According to this embodiment, the light guide plate 7 is schematically formed in a substantially rectangular shape, as shown in FIGS. 1 and 2. The light guide plate 7 is arranged on the rear side (X2 side) of the display portion 10 and has a function of guiding backlight emitted from the LEDs 42 to the display portion 10. Furthermore, the light guide plate 7 is configured such that the light incident surface 71 receiving light emitted from the LEDs 42 is opposed to the LEDs 42, as shown in FIG. 6. The light guide plate 7 is made of resin (acrylic resin, for example). The light guide plate 7 has a pair of positioning portions 72 in the vertical direction (direction Z), as shown in FIG. 2. The positioning portions 72 are formed at positions corresponding to the protrusion portions 34 of the heat sink 3. The positioning portions 72 engage with the protrusion portions 34, whereby the light guide plate 7 is arranged at a prescribed position.

The optical sheet 8 is provided on the front side (X1 side) of the light guide plate 7, as shown in FIGS. 5 and 6. The optical sheet 8 has a function of efficiently transferring light emitted from the light guide plate 7 to the display portion 10.

The resin frame 9 is configured to fix the light guide plate 7 to a prescribed position, as shown in FIGS. 5 and 6.

The display portion 10 (see FIG. 6) is configured to display an image on the front side (X1 side). The display portion 10 is mainly constituted by a liquid crystal cell. On the front side of the display portion 10, the antireflection sheet 11 is arranged, as shown in FIGS. 5 and 6.

According to this embodiment, as hereinabove described, the reflective sheet 6 including the heat reflecting portion 61 capable of reflecting the heat radiated from the heat sink 3 to the heat sink 3 on the rear side is arranged between the light guide plate 7 and the heat sink 3, and the heat sink 3 includes the heat releasing holes 33 configured to release the heat reflected by the heat reflecting portion 61 to the rear side of the heat sink 3, whereby accumulation of the heat reflected by the heat reflecting portion 61 between the heat reflecting portion 61 (reflective sheet 6) and the heat sink 3 can be suppressed by releasing the heat reflected by the heat reflecting portion 61 to the rear side of the heat sink 3 while the heat reflecting portion 61 suppresses transfer of the heat radiated from the heat sink 3 to the light guide plate 7 through the reflective sheet 6. Thus, a user can be suppressed from visually recognizing the shape of the heat sink 3 due to the heat radiated from the heat sink 3. Consequently, a reduction in the display quality of the TV 100 resulting from the heat radiated from the heat sink 3 can be suppressed.

According to this embodiment, the heat releasing holes 33 include the through-holes. Thus, the heat releasing holes 33 can be easily provided.

According to this embodiment, the plurality of heat releasing holes 33 are formed at the positions of the reflective sheet 6 opposed to the heat reflecting portion 61, and the heat sink 3 is configured to release heat to the rear side of the heat sink 3 through the plurality of heat releasing holes 33, whereby the heat reflected to the heat sink 3 by the heat reflecting portion 61 can be easily released to the rear side of the heat sink 3 through the plurality of heat releasing holes 33, and hence the accumulation of the heat reflected by the heat reflecting portion 61 between the heat reflecting portion 61 (reflective sheet 6) and the heat sink 3 can be easily suppressed.

According to this embodiment, the plurality of heat releasing holes 33 are arranged such that the central portions C of the plurality of heat releasing holes 33 are spaced from each other at the substantially equal distances D. Thus, the plurality of heat releasing holes 33 are arranged in a balanced manner, and the heat reflected by the heat reflecting portion 61 is released to the rear side of the heat sink 3, whereby the accumulation of the heat reflected by the heat reflecting portion 61 between the heat reflecting portion 61 and the heat sink 3 can be effectively suppressed.

According to this embodiment, the opening density of the heat releasing holes 33 of the heat sink 3 is increased as the distance of the heat releasing holes 33 from the LEDs 42 is increased. Thus, the heat of the LEDs 42 can be efficiently absorbed by the heat sink 3 in a region where the distance of the heat releasing holes 33 from the LEDs 42 is relatively small, and the heat reflected to the heat sink 3 by the heat reflecting portion 61 can be efficiently released to the rear side of the heat sink 3 through the heat releasing holes 33 in a region where the distance of the heat releasing holes 33 from the LEDs 42 is relatively large. Thus, the reduction in the display quality of the TV 100 resulting from the heat radiated from the heat sink 3 can be suppressed while the LEDs 42 are efficiently cooled.

According to this embodiment, the heat releasing holes 33 are formed such that the total opening area is increased as the distance of the heat releasing holes 33 from the LEDs 42 is increased, whereby the opening density can be easily increased as the distance of the heat releasing holes 33 from the LEDs 42 is increased. Thus, the heat of the LEDs 42 can be easily, efficiently absorbed by the heat sink 3 in the region where the distance of the heat releasing holes 33 from the LEDs 42 is relatively small, and the heat reflected to the heat sink 3 by the heat reflecting portion 61 can be easily, efficiently released to the rear side of the heat sink 3 through the heat releasing holes 33 in the region where the distance of the heat releasing holes 33 from the LEDs 42 is relatively large. Therefore, the reduction in the display quality of the TV 100 resulting from the heat radiated from the heat sink 3 can be suppressed while the LEDs 42 are efficiently cooled.

According to this embodiment, the inner diameter of the plurality of heat releasing holes 33 is increased as the distance of the heat releasing holes 33 from the LEDs 42 is increased. Thus, the inner diameter of the heat releasing holes 33 is increased, whereby the opening density can be easily increased.

According to this embodiment, the heat sink 3 is formed of a plate-like metal member, and the heat releasing holes 33 are formed in the plate-like heat sink 3. Thus, the heat of the LEDs 42 can be efficiently radiated by the heat sink 3 formed of the plate-like metal member, and the heat releasing holes 33 can be easily formed in the plate-like heat sink 3.

According to this embodiment, the heat sink 3 and the heat reflecting portion 61 of the reflective sheet 6 are arranged in the state where the same are separated from each other at the prescribed interval in the anteroposterior direction, and the heat sink 3 is configured to release the heat reflected by the heat reflecting portion 61 to the rear side through the heat releasing holes 33, whereby heat is radiated from the heat sink 3 to the heat reflecting portion 61 through air between the heat sink 3 and the heat reflecting portion 61, and hence the heat of the heat sink 3 is hardly directly transferred to the heat reflecting portion 61.

According to this embodiment, the rear frame 2 arranged on the rear side of the heat sink 3 is provided, and the heat released to the rear side through the heat releasing holes 33 is radiated through the rear frame 2. Thus, the heat released to the rear side through the heat releasing holes 33 can be easily radiated through the rear frame 2.

According to this embodiment, the rear frame 2 made of resin whose inner surface is black is arranged on the rear side of the heat sink 3, whereby the heat released to the rear side of the heat sink 3 can be efficiently absorbed by the rear frame 2. Thus, the accumulation of the heat reflected by the heat reflecting portion 61 between the heat reflecting portion 61 (reflective sheet 6) and the heat sink 3 can be effectively suppressed.

According to this embodiment, the heat reflecting layer made of metal is formed on the rear side of the reflective sheet 6 made of resin, whereby transfer of the heat radiated from the heat sink 3 to the display portion 10 can be easily suppressed by the heat reflecting layer made of metal even in the case where the reflective sheet 6 is made of resin.

According to this embodiment, the heat reflecting portion (heat reflecting layer) 61 is formed of a tape member made of metal (aluminum). Thus, the heat reflecting portion (heat reflecting layer) 61 can be thinned, and hence an increase in the thickness of the TV 100 in the anteroposterior direction can be suppressed.

According to this embodiment, the plurality of LEDs 42 are arranged to be opposed to the light incident surface 71 of the light guide plate 7, and the heat reflecting portion 61 is formed from the region corresponding to the end 6b of the first side along the light incident surface 71 to the region corresponding to the end 6c of the second side along the light incident surface 71, whereby the heat reflecting portion 61 can be provided in a region in the vicinity of the LEDs 42 where the temperature of the heat sink 3 is easily increased, and hence the transfer of the heat radiated from the heat sink 3 to the display portion 10 can be effectively suppressed by the heat reflecting portion 61.

According to this embodiment, the heat sink 3 is arranged to overlap with the heat reflecting portion 61 of the reflective sheet 6. Thus, the heat reflected by the heat reflecting portion 61 can be efficiently radiated from the heat sink 3.

According to this embodiment, the heat releasing holes 33 of the heat sink 3 are formed in the heat sink 3 to overlap with the heat reflecting portion 61 of the reflective sheet 6. Thus, the heat reflected by the heat reflecting portion 61 can be efficiently released to the rear side of the heat sink 3.

According to this embodiment, the interval between the heat sink 3 and the flat portion of the rear frame 2 is larger than the interval between the heat sink 3 and the reflective sheet 6. Thus, the heat reflected by the heat reflecting portion 61 can be suppressed from staying between the heat sink 3 and the rear frame 2.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the present invention is applied to the TV (television set) as the display device in the aforementioned embodiment, the present invention is not restricted to this. The present invention is also applicable to another display device, such as a monitor of a PC (personal computer).

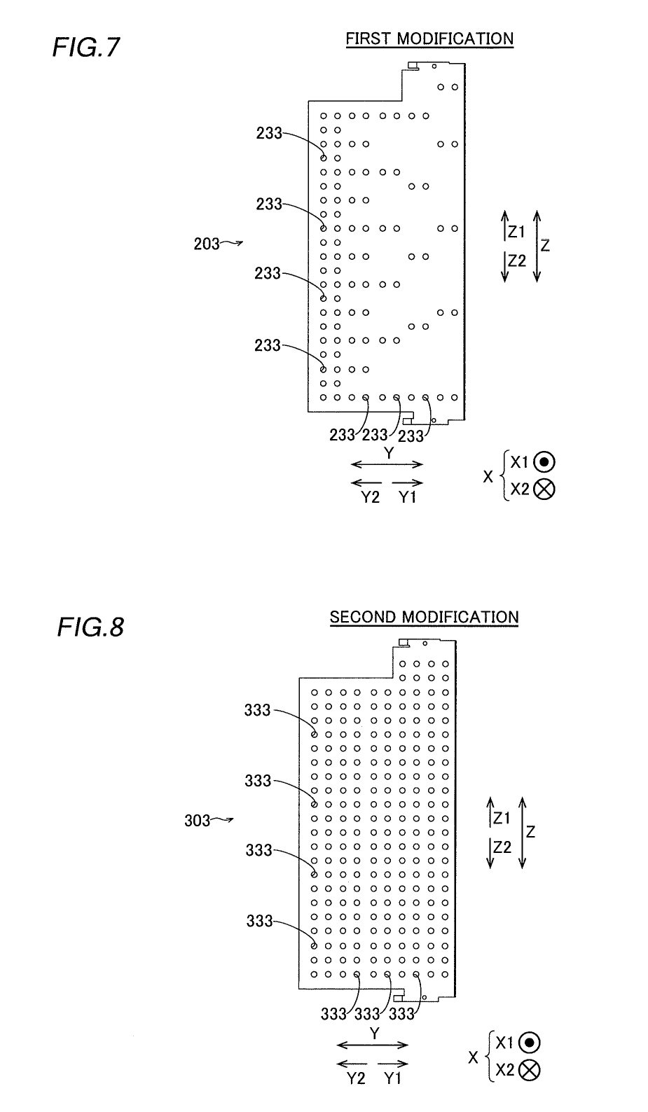

While the inner diameter of the heat releasing holes 33 is varied so that the total opening area of the heat releasing holes 33 of the heat sink 3 is increased as the distance of the heat releasing holes 33 from the LEDs 42 is increased in the aforementioned embodiment, the present invention is not restricted to this. According to the present invention, the total opening area of heat releasing holes 233 of a heat radiation member 203 may alternatively be increased as the distance of the heat releasing holes 233 from a light source (LEDs 42) is increased by forming the heat radiation member 203 such that the inner diameter of the heat releasing holes 233 is constant but the number of the heat releasing holes 233 is increased as the distance of the heat releasing holes 233 from the light source is increased, as in a first modification shown in FIG. 7. Thus, the heat of the light source can be efficiently absorbed by the heat radiation member 203 simply by varying the arrangement of the heat releasing holes 233 without varying the inner diameter of the heat releasing holes 233, and heat reflected to the heat radiation member 203 by a heat reflecting portion can be efficiently released to the rear side of the heat radiation member 203 through the heat releasing holes 233 in a region where the distance of the heat releasing holes 233 from the light source is relatively large. Furthermore, according to the present invention, the total opening area of heat releasing holes 333 of a heat radiation member 303 may alternatively be substantially constant by forming the heat radiation member 303 such that the inner diameter of the heat releasing holes 333 is constant and the number of the heat releasing holes 333 is constant (the ratio of distribution of the heat releasing holes 333 is constant) even if the distance of the heat releasing holes 333 from a light source is increased, as in a second modification shown in FIG. 8. Thus, the arrangement of the heat releasing holes 333 may not be complicated, and hence the heat radiation member 303 including the heat releasing holes 333 can be easily formed.

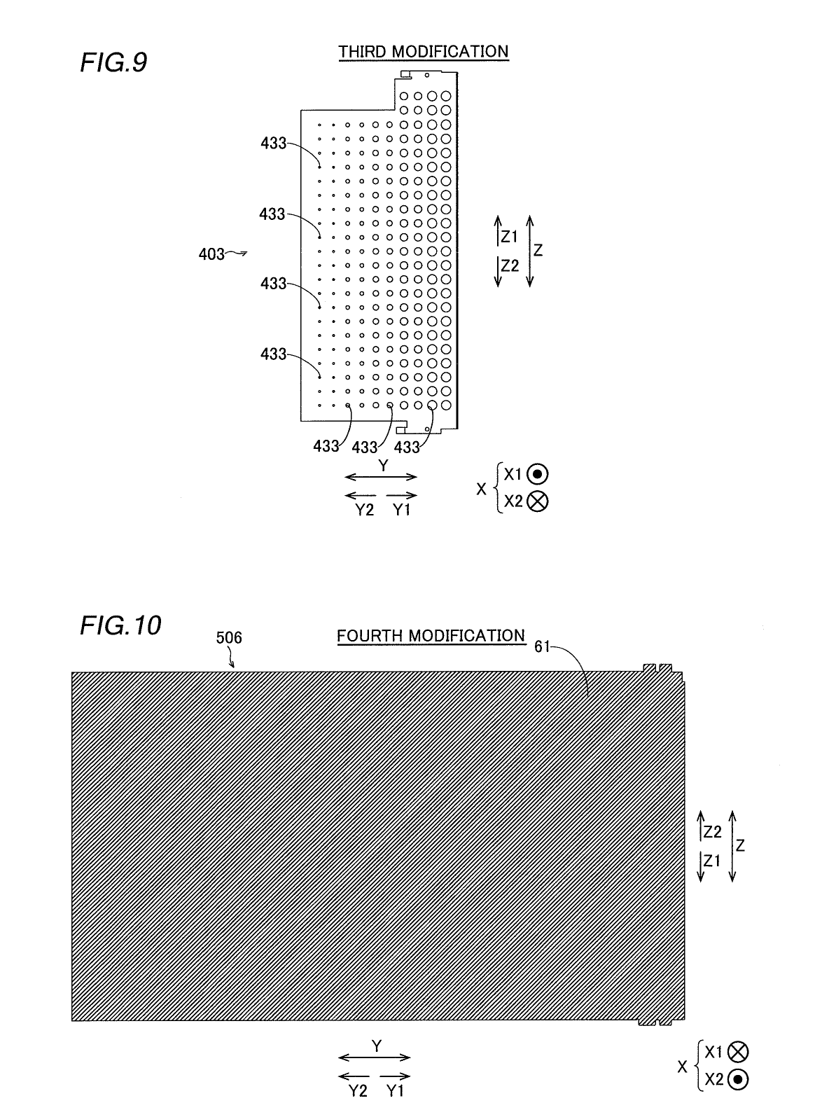

As in a third modification shown in FIG. 9, the total opening area of heat releasing holes 433 of a heat radiation member 403 may alternatively be reduced as the distance of the heat releasing holes 433 from a light source is increased. Thus, heat reflected to the heat radiation member 403 by a heat reflecting portion can be promptly released to the rear side of the heat radiation member 403 through the heat releasing holes 433 in the vicinity of the light source, and hence the amount of heat diffusing to a region of the heat radiation member 403 corresponding to the central side of a display portion is reduced, so that accumulation of heat in the region of the heat radiation member 403 corresponding to the central side of the display portion can be suppressed. Consequently, a reduction in the display quality of a central region of a display device can be further suppressed.

While the heat sink 3 and the heat reflecting portion 61 are arranged in the state where the same are separated from each other at the prescribed interval in the anteroposterior direction in the aforementioned embodiment, the present invention is not restricted to this. According to the present invention, the heat radiation member and the heat reflecting portion may alternatively be arranged in a state where the same come into close contact with each other in the anteroposterior direction. Thus, an increase in the thickness of the display device in the anteroposterior direction can be suppressed.

While the rear frame 2 whose inner surface is black is provided in the aforementioned embodiment, the present invention is not restricted to this. According to the present invention, a rear frame whose inner surface is blackish colored (charcoal gray or the like, for example) may alternatively be provided.

While the rear frame 2 is made of resin in the aforementioned embodiment, the present invention is not restricted to this. According to the present invention, the rear frame may alternatively be made of metal. Thus, heat released to the rear side of the heat radiation member can be easily absorbed by the rear frame and radiated to the outside.

While the reflective sheet 6 is made of resin in the aforementioned embodiment, the present invention is not restricted to this. According to the present invention, the reflective sheet may alternatively be made of metal.

While the heat reflecting portion 61 is provided at the position corresponding to the heat sink 3 in the aforementioned embodiment, the present invention is not restricted to this. According to the present invention, a heat reflecting portion may alternatively be formed on the entire surface of a reflective sheet 506 on the rear side, as in a fourth embodiment shown in FIG. 10.

While the heat sink 3 in the shape corresponding to the partial region of the light guide plate 7 on the Y1 side is provided in the aforementioned embodiment, the present invention is not restricted to this. According to the present invention, a heat radiation member in a shape corresponding to a substantially entire region of the light guide plate may alternatively be provided.

What is claimed is:

1. A display device comprising:
a display portion displaying an image on a front side;
a light guide plate arranged on a rear side of the display portion, guiding backlight emitted from a light source to the display portion;
a heat radiation member arranged on a rear side of the light guide plate, radiating heat of the light source; and
a reflective sheet arranged between the light guide plate and the heat radiation member, including a heat reflecting portion capable of reflecting the heat radiated from the heat radiation member to the heat radiation member on a rear side, wherein
the heat radiation member includes a heat releasing portion configured to release the heat reflected by the heat reflecting portion to a rear side of the heat radiation member.

2. The display device according to claim 1, wherein
the heat releasing portion includes a heat releasing hole that is a through-hole.

3. The display device according to claim 2, wherein
the heat releasing portion of the heat radiation member includes a plurality of heat releasing holes,
the plurality of heat releasing holes are formed at positions of the reflective sheet opposed to the heat reflecting portion, and
the heat reflected to the heat radiation member by the heat reflecting portion is released to the rear side of the heat radiation member through the plurality of heat releasing holes.

4. The display device according to claim 3, wherein
the plurality of heat releasing holes are arranged such that centers thereof are spaced from each other at a substantially equal distance.

5. The display device according to claim 3, wherein
the heat releasing holes of the heat radiation member are formed such that an opening density of the heat releasing holes is increased as a distance of the heat releasing holes from the light source is increased.

6. The display device according to claim 5, wherein
the heat releasing holes of the heat radiation member are formed such that a total opening area of the heat releasing holes is increased as the distance of the heat releasing holes from the light source is increased.

7. The display device according to claim 5, wherein
an inner diameter of the plurality of heat releasing holes is increased as the distance of the heat releasing holes from the light source is increased.

8. The display device according to claim 2, wherein
the heat radiation member is formed of a plate-like metal member, and
the heat releasing hole is formed in the heat radiation member that is plate-like.

9. The display device according to claim 3, wherein
the heat radiation member and the heat reflecting portion of the reflective sheet are arranged in a state where the heat radiation member and the heat reflecting portion of the reflective sheet are separated from each other at a prescribed interval in an anteroposterior direction, and
the heat radiation member is configured to release the heat reflected by the heat reflecting portion to the rear side through the heat releasing holes.

10. The display device according to claim 9, further comprising a rear frame arranged on the rear side of the heat radiation member, wherein
the heat released to the rear side through the heat releasing holes is radiated through the rear frame.

11. The display device according to claim 1, further comprising a rear frame made of resin, arranged on the rear side of the heat radiation member, wherein
the rear frame is configured such that an inner surface thereof is blackish colored.

12. The display device according to claim 1, wherein
the reflective sheet is made of resin, and
a heat reflecting layer made of metal, capable of reflecting the heat radiated from the heat radiation member to the heat radiation member is formed on a rear side of the reflective sheet.

13. The display device according to claim 12, wherein
the heat reflecting layer is formed of a tape member made of metal or formed by depositing metal on the reflective sheet.

14. The display device according to claim 1, wherein
a plurality of light sources are arranged to be opposed to a side surface of the light guide plate serving as a light incident surface, and
the heat reflecting portion is formed from a region corresponding to an end of a first side along the light incident surface in a direction in which the light source is arranged to a region corresponding to an end of the second side along the light incident surface in the reflective sheet.

15. The display device according to claim 3, wherein
the heat releasing holes of the heat radiation member are formed such that a total opening area of the heat releasing holes is reduced as a distance of the heat releasing holes from the light source is increased.

16. The display device according to claim 1, wherein
the heat radiation member is arranged to overlap with the heat reflecting portion of the reflective sheet.

17. The display device according to claim 16, wherein
at least the heat releasing portion of the heat radiation member is formed in the heat radiation member to overlap with the heat reflecting portion of the reflective sheet.

18. The display device according to claim 10, wherein
an interval between the heat radiation member and a flat portion of the rear frame is larger than an interval between the heat radiation member and the reflective sheet.

19. The display device according to claim 1, being a television set including a receiver receiving television broadcasting.
